(19) United States
(12) Patent Application Publication
(10) Pub. No.: US 2016/0232416 A1
(43) Pub. Date: Aug. 11, 2016

(54) Vital Data Assistant

(71) Applicant: Thomas Ralph Rossi, Villa Park, CA (US)

(72) Inventor: Thomas Ralph Rossi, Villa Park, CA (US)

(21) Appl. No.: 14/617,355

(22) Filed: Feb. 9, 2015

(51) Int. Cl. G06K 9/18; G06K 9/00

(52) U.S. Cl. CPC G06K 9/18; G06K 9/00442

(57) ABSTRACT

A small medallion is disclosed, which contains a QR code, a phone number, and an alphanumeric code, which the user can input on a website. The user may then associate medical history information, information regarding next-of-kin or personal contacts, and information such as a will or instructions for continuity of a business with the QR code and alphanumeric code. If the user is ever need of emergency assistance, a paramedic who finds the user can scan the QR code, communicate the alphanumeric code to a contact center, and then the contact center will inform the medical center where the user is to be taken for treatment about the user's medical history information, personal contact information, and legal information. A system, which includes steps for ensuring that a user's medical, personal contact, are available in emergencies is also disclosed. A method of learning through which includes steps for ensuring that a user's medical, personal contact, are available in emergencies is also disclosed.

### REFERENCES CITED

U.S. PATENTS

| Pat. No. | Authors | Filing Dates |
|---|---|---|
| 8,924,712 | Varadarajan | Aug. 29^{th}, 2012 |
| 8,918,643 | Okude | Nov. 13^{th}, 2008 |
| 8,915,433 | Simske | Mar. 5^{th}, 2013 |
| 8,908,927 | Atsmon, et. al. | Aug. 16^{th}, 2012 |
| 8,893,974 | Pawlik | Nov. 30^{th}, 2012 |
| 8,884,751 | Baldocchi | Jul. 1^{st}, 2011 |
| 8,881,990 | Hunt et. al. | Sep. 7^{th}, 2012 |
| 8,740,089 | Walton III | Oct. 8^{th}, 2013 |
| 8,857,705 | Larson et. al. | Jan. 11^{th}, 2013 |
| 8,843,382 | Kim | Oct. 18^{th}, 2012 |
| 8,775,209 | Auchinleck | Oct. 12^{th}, 2006 |
| 7,967,190 | Hussey | Jun. 20^{th}, 2008 |
| 7,578,432 | Libin | Dec. 7^{th}, 2006 |

U.S. PATENT APPLICATIONS

| Application Number | Authors | Filing Dates |
|---|---|---|
| 20140380445 | Tunnell et. al. | Mar. 17th, 2014 |
| 20140379374 | Vinals | Aug. 1^{st}, 2013 |
| 20140358584 | Worden | May 23^{rd}, 2014 |
| 20140343962 | Xu | May 14^{th}, 2013 |
| 20140316812 | Hathorn et. al. | Apr. 22^{nd}, 2014 |
| 20140304183 | Zabar | Apr. 1^{st}, 2014 |
| 20140244296 | Linn et. al. | Mar. 14^{th}, 2013 |
| 20140155827 | Ostrander et. al. | May 31^{st}, 2013 |
| 20140142979 | Mitsunaga | Nov. 21^{st}, 2012 |
| 20140122053 | Lotan et. al. | Oct. 25^{th}, 2012 |
| 20140006051 | Vuong et. al. | Jun. 27^{th}, 2012 |
| 20130197941 | Cochran | Jan. 29^{th}, 2013 |
| 20130030838 | Myers et. al. | Jul. 29^{th}, 2011 |

### PRIORITY CLAIM

This application claims priority to U.S. provisional application No. 62/124,925, by the inventor Thomas Ralph Rossi, which is hereby incorporated by reference in its entirety.

### DESCRIPTION OF THE RELATED ART

QR codes are two-dimensional unique pictures that can be scanned by the digital scanning functions of cellular phones and other devices. QR codes have, in recent years, been used for identification of various objects, and have also been used as access codes for various mobile websites, and for the purpose of accessing different types of information. The cell phone will scan the QR code and the phone is linked to a specific website or other address.

Alphanumeric codes are sequences of letters, numbers, symbols, or a combination thereof, which are also used for unique identification of various websites, and as access codes for different types of information. The serial numbers which keep track of unique items are usually a form of alphanumeric codes.

Emergency services include emergency responders such as paramedics. When paramedics locate a person who needs emergency medical assistance, the paramedics will usually take that person to a hospital or other medical center. While the patient is being transported to the medical center, and after the patient arrives, the patient's medical history is important to determining the appropriate treatment to be given to the patient. The patient's next of kin should also be informed of the patient's status. The patient's next of kin may have other important information about the patient, which may aid in the patient's treatment.

In many cases the paramedics, and the medical center, will have no information about the patient's medical history when he or she arrives at the medical center. Some methods and systems for quickly informing a medical center about the medical history, and next of kin, of a new patient at the medical center, when the patient is unable to communicate this information himself, are known. These methods and systems, however, all suffer from various drawbacks. Our invention solves these drawbacks.

In this patent, the term “contact center” may refer to the contact center or the human personnel employed at the contact center.

A brief review of the prior art will follow.

One conventional device, MedicAlert IDs, include custom engraved medical ID bracelets and necklaces with a 24-hour emergency medical information service. The MedicAlert IDs are engraved with the user's most critical health information, such as medical conditions, prescription and over-the-counter medications and dosages, allergies, implanted medical devices, emergency contact persons, physician information, or health insurance information. The MedicAlert ID has a 24-hour emergency response phone number that emergency responders and medical personnel are trained to call. The MedicAlert team relays the person's vital medical information within seconds, to ensure the person receives a safe, effective, and quick treatment. The MedicAlert team may also send electronic records to the hospital on the person's behalf and ensures the emergency contact persons are notified.

Our devices, methods, and systems are different from MedicAlert because they are more secure than MedicAlert. In our devices methods, and systems, the user's medical records are not stored with the user, but are instead stored on a secure user information database. This methodology can store much more information than can be found on a MedicAlert bracelet. Some embodiments of our invention have two codes, the QR code and the numerical code, which can be used by an emergency responder to communicate with a human-manned contact center. This feature is not present in MedicAlert.

Our devices, methods, and systems also involve the unique “Vital Data Assistant Medallion”, or VDA medallion. The VDA Medallions can be placed adhesively on other objects, and are much smaller than MedicAlert IDs, therefore, they are easier for the user to carry. A user may also carry several VDA medallions, all of which have been registered to his name, attached to different objects. This is a difference from the MedicaAlert ID, which is a bracelet that fits around the user's wrist.

An additional conventional device, an invisible bracelet, is an emergency personal identification number (PIN) displayed on a wallet card, keychain, sticker or snap-on device for clothing. In an emergency, the person's invisible bracelet PIN can help identify them, alert first responders to the person's important health information, and notify the person's emergency contacts. When an invisible bracelet identifier is found during an emergency, a first responder can enter the PIN into any SMS-enabled (i.e., text-enabled) phone. The invisible bracelet PIN is texted to the emergency service corresponding to the invisible bracelet. The service returns an emergency alert message with the important health information previously provided by the person. First responders can interact with the service to notify the person's emergency contacts or get more detailed information that the person previously chose to share.

Our invention also has the same advantages over this invention as it does over MedicAlert. Furthermore, both the Medicalert device and invisible bracelet device suffer from the drawback that they can be stolen by thieves, who may perceive them to be of value. If a Medicalert bracelet or invisible bracelet is stolen, the information on it will be lost. Our invention relies on small medallions, and so is less noticeable and less vulnerable to theft. Additionally, our invention can store much more information in its medical records database than MedicAlert can.

These conventional devices lack, among other things, the additional level of security for user health data created by our invention. In most embodiments, our invention does not display user medical history directly to emergency responders or to unauthorized third parties, but instead to medical centers. In our invention, the contact center, and the personnel working at the contact center, act as a “gatekeeper” to ensure that information is not released to unauthorized third parties. This is more secure, and ensures that unauthorized people do not access the user's QR code or alphanumeric code.

The invisible bracelets also lack the robustness of a QR code-based medical history system that delivers essential health information to medical providers in a quick and efficient web and smartphone based platform.

The inventor is informed that there may exist “apps” that perform some of the same functions as the present invention. However, these apps are not believed to include anything similar to the security that our invention provides regarding user medical data. Furthermore, these “apps”, if they exist, do not include the present invention's capability of the user buying a large number of adhesive stickers of the same type, in a pack, containing the same numerical code, to use as the basis for the user's identification.

Several inventors have filed U.S. patents and patent applications which should be mentioned here.

Varadarajan's invention involves identifying and authenticating various transactions related to ATMs. It cannot be compared to our invention, because our invention involves health care data for individual patients, which must be secured because of HIPAA. Our invention also involves specific medallions, the “VDA medallions”, which have a certain size, shape, and capabilities, which are not approximated by anything in Varadarajan's invention.

Okude describes an authenticating system which involves a portable terminal and a storage unit, and which authenticates the portable terminal by comparing the authentication information for the portable terminal with that for the storage unit. The intent of Okude's invention is different from that of our invention, and our invention also involves specific medallions, the “VDA medallions”, which have a certain size, shape, and capabilities, which are not approximated by anything in Okude's invention.

Simske's invention involves examining the difference between a first identifier and a second identifier, and determining whether the second identifier is an eligible identifier based on whether or not it satisfies a certain threshold value. Our invention involves at least two identification codes for the user's health care data, and databases for those codes to be placed in. Most embodiments of our invention also involve a gatekeeper for extra security. Our invention also involves specific medallions, the “VDA medallions”, which have a certain size, shape, and capabilities, which are not approximated by anything in Simske's invention.

Atsmon's invention involves a system for comparing live images of a plant to stored images of the way that the plant is supposed to appear, to determine whether the plant is healthy. This is different from our invention, which focuses on storing healthcare data and contact information for relatives of the user, and other information such as information about living trusts, in a centralized database, and then making this information available to medical centers when a user is found to be in need of medical attention.

Pawlik's invention describes a method for capturing an image of a barcode and a copy-evident background and using changes in the image of the copy-evident background introduced by the copying process to authenticate the bar code. This is a different method of authentication from that used in our invention. In addition, our invention also involves specific medallions, the “VDA medallions”, which have a certain size, shape, and capabilities, which are not approximated by anything in Pawlik's invention.

Baldocci's invention is a monitor, about the size of a cellular phone, which is connected to various sensors that monitor a person's vital indicators. The invention contains the ability to contact a third party if the user desires it. This is different from the current invention, because the parts of the current invention that are utilized by the end-user are very small, small enough to be attached on the surface of, for example, a lip balm or lipstick container. Furthermore, in the current invention, the user can place more than one VDA medallion on in different places, and the VDA medallions will have identical codes, which can be factory-assigned. In Baldocci's invention, the user only has one monitor.

U.S. Pat. No. 8,881,990 by Hunt involves a bracelet, with a QR code, that, when scanned by an emergency responder, transmits medical information about the individual holding the bracelet. This invention also includes the possibility of a bracelet having an alphanumeric code on it, which can also be scanned to gain medical information about the patient. The emergency responder can go to a website or call a phone number to get this information.

Our invention is different from that of Hunt in many ways. First, most embodiments of our invention involve the small, self-adhesive VDA medallions. These medallions are physically smaller than Hunt's device, and can be placed in locations where the bracelet of Hunt's invention cannot be placed. For example, a user can stick one of the VDA medallions on his lip balm, and another VDA medallion on his cell phone. The figures and description of Hunt make clear that Hunt's invention is physically much larger than our invention, and must be large enough to fit around a user's wrist. Hunt's invention also suffers from the additional drawback that the bracelet which is part of Hunt's invention can be stolen by thieves believing it to be valuable. This would mean that emergency responders could not access the QR code to get the user's health data.

Furthermore, the information management architecture of our invention is very different from that of Hunt's invention. We desire our invention to be HIPAA-compliant, and so, in most embodiments of our invention, when a VDA medallion's QR code is scanned by an emergency responder, the responder must then call the phone number listed on the medallion, read off the alphanumeric code on the VDA medallion, and then authenticate himself or herself to a live person at the contact center. The contact center then informs a medical center where the user will be treated. The medical center may be one of a list selected by the invention, may be one preselected by the user, or may be one selected by the emergency responder. Furthermore, our invention also includes next-of-kin contact information. The figures and description of Hunt's patent make clear that Hunt's invention is designed to automatically give medical history about the user to the emergency responder. Our invention involves a higher level of security for the user's medical data, as discussed above, and some embodiments of our invention involve several databases focused on different items, in contrast to the one database of Hunt's invention. The emergency responder must authenticate the relevant information through all of the relevant databases before our invention will release any information to the medical center.

Our invention also provides the additional feature that the user can purchase a group of VDA medallions, each of which will have the same QR code. The user can then register his medical history and other instructions with the QR code and alphanumeric code for each of the VDA medallions. Then, the user can place the VDA medallions in multiple places. Because most versions of the VDA medallion are adhesive, they can be “stuck” in multiple places. Then, when an emergency responder finds any one of the VDA medallions, he can scan that medallion and connect to the contact center. This means that a user of our invention is more likely to have one of the medallions with him or close to him, when he is found by an emergency responder. In contrast, the wristbands of Hunt's invention can be taken off, and if for some reason the user loses the wristband of Hunt's invention, emergency responders will not know to access that user's QR code and other medical history.

Hunt's invention also specifically refers to worn items. Our VDA medallions do not need to be “worn” by the user.

Walton's invention discusses a QR code that can be attached to a keychain or bracelet, or ID card, and which may have adhesive material attached to it. The user may input the QR code into a website, and then input his health information into the website. The health information is called up by an emergency responder who scans the QR code with his or her cellular phone.

Our invention is different from that of Walton because, first, our invention involves multiple small, portable medallions that can be placed in different locations by the user. This is different from the QR codes attached to chains or cards discussed by Walton.

Our invention also provides greater data security than Walton does, because, with Walton's invention, anyone who can scan the user's QR code can get access to the user's medical history. With our invention, the emergency responder needs to scan the QR code, read off an alphanumeric code, and prove to the contact center that they are an emergency responder, and then the contact center connects them to a medical center and remits the user's medical history to the medical center. Only the medical center has access to the user's medical data. The doctors at the medical center can then share the user's medical data with the emergency responder as necessary, in their judgment.

Larson's invention focuses on providing a single-scan user interface for a device throughout its life cycle. Larson's invention accomplishes this by providing a mobile device that is joined to the remote device, and which may include a QR code for identification.

Kim's invention involves using a camera to feed clinical information, including ultrasound information, into a centralized hospital database, from which a patient can view the images taken by the camera. The system assigns a QR code to the information, which may be printed on a card.

This is very different from the current invention, which involves a centralized database from which information can be remotely sent (unlike Kim's invention, which seems to involve no data-sharing between medicals centers and be designed to operate only in one hospital).

Auchinleck's invention involves an apparatus for ensuring that babies in a hospital receive their mothers' milk. QR codes are used to keep track of the milk from each mother, to ensure that each baby receives milk from his or her mother.

Hussey's invention discusses a health care management network comprising an optical QR code reader electronically connected to a base station.

Our invention is different in purpose and construction from these two inventions. Our invention involves the user's healthcare data and other data pre-authorized by the user for release being stored in a server which can remotely send the information to medical centers, upon receipt of a QR code and an alphanumeric code, and proper authentication of the user.

Libin's invention involves storing patient information in a hospital database, where the information is given a unique electronic identifier such as a QR code. The individual then keeps a copy of this electronic identifier in a convenient place. When an emergency happens and emergency medical personnel arrive on the scene, they scan the electronic identifier, and are given the patient's medical history.

Our invention differs from Libin's invention, first, because our invention utilizes the specific VDA medallions, which are a specific physical object that can be attached to other objects in a specified way, and which carries the user's QR code. Our invention also includes much greater protection for the user's health care information, and emergency contact information, than Libin. In our invention, information is released to the medical center where a patient will be treated, but is not released to emergency medical personnel. This is because there is too great a chance of unauthorized persons gaining access to the patient's medical or emergency contact information, if it is released to anyone who scans the user's QR code.

Tunnel's invention seems to be focused on locking mechanisms. Our invention goes beyond the purpose of Tunnel's invention, in that our invention also involves a storage system for healthcare data, and the capability to send this healthcare data to medical centers when necessary.

Vinals' invention is specifically adapted to the context of a medical office and/or a hospital. It is very different from the present invention. Vinals also does not appear to make use of QR codes at all, to identify patients or for any other reason. That means that our invention includes an ability to categorize each patient by a unique identifier that is not present in Vinals' invention.

Our system, which allows an EMT who finds an unconscious user to authenticate themselves, give two codes to a contact center, and cause information to be sent to a medical center (a fourth party) is completely different from the invention of Worden, which seems to focus primarily on sharing information when on a visit to a doctor's office.

Xu's invention is focused on sending informative videos to patients after the patient has identified himself and asked to be shown the video. There is nothing in Xu's invention about emergency responders (third parties) identifying themselves and having medical information about an unconscious user sent to a medical center (a fourth party) when an unconscious user is found. Xu's invention also does not seem to contain anything about storage of the patient's information. This is a difference between Xu's invention and our invention.

Hawthorn's invention is different from our invention because Hawthorn's invention is designed to work through the patient scanning a QR code when he physically enters the facility. This is different from our invention, which has a third party (the emergency responder) giving the QR code and an alphanumeric code remotely to a centralized database, after which the contact center sends the user's medical history to the trauma center or medical center.

Hawthorn also includes nothing about scanning codes on stickers or small medallions like our “VDA Medallion”.

Next-of-kin data is not “PH1” data of the sort discussed in Hawthorn, furthermore. Hawthorn's invention seems to be focused on only allowing a person to register with one facility, which is different from our invention, which allows a user to register with a centralized database, which connects to different cities.

Zabar's invention uses an individual QR code to verify a person's credentials. This is different, however, from our invention, where an emergency responder verifies his or her credentials independently of the QR code, and has the user's medical information sent to a third party, a medical center or trauma center. The protections must be bigger with our invention because of the laws related to healthcare data.

Myers' unified medical record retrieval system is different from the present invention because Myers' system does not include the whole concept of having information accessible to a fourth party (a medical center) when an authenticated third party (the emergency responder), announces that this is necessary. Myers' system also does not contain the ability to inform a next-of-kin who then might be able to update the hospital in real time. Our invention has these two features.

Cochran's method does not include all the elements of our method. It does not include the capability for information to be accessible to a medical center after an emergency responder informs the central control of the need for this. Cochran's invention also does not have the ability to inform a next-of-kin who then might be able to update the hospital in real time. Our invention also includes additional safety features associated with the user's medical and legal information.

Ostrander's invention focuses on medicament devices, and tracking them. It does not have, and is not designed to have, the same capabilities as our invention. Our specialized equipment with QR codes is different from the invention outlined in Ostrander's application. Ostrander's application is unclear about the type of authentication that an individual would have to make, in order to access tracking data. Furthermore, part of the purpose of our invention is that, after receiving authentication from an emergency responder, our system will take data regarding a user's medical history and send it to a medical center. Ostrander's invention does not have this capability. Our system can also be configured so as to allow a doctor at a medical center, who has been sent the user's medical history, to directly instruct an emergency responder about what to do to help the user, while the user is being transported to the medical center.

Mitsunaga's invention has a different purpose from our invention, and therefore lacks the level of assurance of security of users' healthcare and other data which is present in our invention. Mitsunaga's invention also lacks the durable instruments on which QR codes are written, which are the VDA medallions. Furthermore, these can be acquired from a group, and acquired in a store. Mitsunaga's system includes nothing similar. Our system can theoretically also be used to provide real-time information from next of kin.

Lotan's invention is designed to store personal medical data on a server. When the user desires, the user can contact the server via a cellular phone, and then identify himself or herself via voice recognition (using IVR technology) or in other ways. The server then releases the medical information. Our invention is based on different principles, because it uses specialized equipment with QR codes and alphanumeric codes to identify the user whose medical information needs to be released, and it can release medical information on command from someone besides the user. In addition, our system can transmit the user's medical history information to a hospital if needed. Our invention also includes the capability for a doctor at the hospital to tell a paramedic the necessary steps to take to treat a user, while the user is being carried to the hospital.

Vuong's invention involves a system for quickly accessing personal healthcare data in an emergency. Vuong's invention differs from our invention in various ways. For example, Vuoung does not have the information management architecture of our invention, by which a user's medical information is sent to a medical center when an emergency responder informs the contact center of the need for this. Vuong's invention also does not involve the specialized “VDA medallions” which our invention involves. The “VDA medallions” make our invention more effective, because the user can stick multiple VDA medallions on different objects, which increases the chances that an emergency responder will find one of these objects if the user ever needs emergency medical assistance. Then the emergency responder will set in motion a process, to arrange for medical information about the user to be sent to the appropriate medical center via the service. Our invention also involves the additional benefit of added security for the user's medical data, in that the medical data is only released to a medical center via the service.

### SUMMARY OF THE INVENTION

### Term Numbers

The following term numbers will be used to refer to different components of embodiments of the invention. Some embodiments may include certain components of the invention, but not others.
(1) VDA medallion. (2) VDA medallion group. (3) QR Code. (4) Alphanumeric code. (5) Medical center. (6) Medical history database. (7) Contact center. (8) Adhesive base. (9) Display device. (10) QR code recognition component. (11) Alphanumeric code recognition component. (12) QR code database. (13) Alphanumeric code database. (14) Initial subscription form. (15) Medical center database. (16) Computer. (17) Computer readable medium. (18) Emergency responder authentication database. (19) Telephone number. (20) Personal contact database. (21) Legal database. (22) Linking feature. (23) Querying feature. (24) User information database.
The linking feature can automatically link the emergency responder's phone to the contact center, once the scanned QR code and alphanumeric code are sent to the contact center. This feature is present in some embodiments of the invention.
The telephone number goes to the contact center.

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The word “exemplary” is used herein to mean “serving as an example, instance, or illustration.” Any embodiment described herein as “exemplary” is not necessarily to be construed as preferred or advantageous over other embodiments. Likewise, the terms “embodiment(s) of the invention”, “alternative embodiment(s)”, and “exemplary embodiment(s)” do not require that all embodiments of the method, system, and apparatus include the discussed feature, advantage or mode of operation. The following description of the preferred embodiment is merely exemplary in nature and is in no way intended to limit the invention, its application, or use.

The term “computer” as used herein includes any device that electronically executes one or more programs, such as personal computers (PCs), hand-held devices, multi-processor systems, microprocessor-based programmable consumer electronics, network PCs, minicomputers, tablets, smartphones, mainframe computers, routers, gateways, hubs and the like. The term “program” as used herein includes applications, routines, objects, components, data structures and the like that perform particular tasks or implement particular abstract data types. The term “program” as used herein further may connote a single program application or module or multiple applications or program modules acting in concert. The data processing aspects of the invention also may be employed in distributed computing environments, where tasks are performed by remote processing devices that are linked through a communications network. In a distributed computing environment, programs may be located in both local and remote memory storage devices.

The term “computer readable medium” includes any information storage and retrieval system designed to be read by computers.

The term “display device” includes any device capable of electronically displaying information.

For purposes of this application, an “emergency responder” is a person whose job description involves dealing with the emergency needs of individuals who are hurt or in need of medical services, and/or ensuring that individuals who are hurt or in need of medical services arrive at medical centers where they can be treated. Emergency responders may include paramedics, emergency medical technicians, policemen, firemen, and others.

For purposes of this application, a “medical center” is a place where patients are treated under the care of one or more physicians. Medical centers may include, but not be limited to, hospitals and trauma centers.

For purposes of this application, a “user” is a person who has purchased one or more “Vital Data Assistant” medallions (VDA medallions) and subscribed to the service, whereby they have entered information about their medical history into the medical history database (6), and/or entered information about their personal contact to call in the event of an emergency (“emergency contact” or “next of kin”) in the personal contact database (20), and/or entered information about any living trust, will, or other legal document in the legal database (21).

The phone number printed on the medallions in the illustrations is for example purposes only. The VDA system does not need to use that phone number, and, indeed, the VDA system could practically utilize any phone number.

### FIELD OF THE INVENTION

This invention relates generally to the field of storing and retrieving personal health and contact information for retrieval in emergency situations.

### Some of the Needs the Invention was Designed to Fill

In the United States, there are many occasions when an injured person or crime victim may be found by emergency responders and taken to a medical center for treatment. An example might be an individual who has suffered a heart attack while jogging, and who is found by paramedics by the side of a road. Such injured persons or crime victims may be unconscious, or otherwise unable to communicate. Therefore, in such cases, an injured person may not be able to inform the emergency responders about his or her identity, or about his or her medical history.

Victims of automobile accidents or temporarily debilitating injuries, such as strokes, may be temporarily unable to communicate with emergency responders. They will therefore be unable to convey any information about their medical history, injuries, or next of kin or emergency contacts.

Individuals with dementia or who are otherwise compromised, who need medical attention, may also be unable to communicate their symptoms, medical history, or information about their family members to emergency responders or other medical personnel.

Individuals who are injured and who simply do not know their medical history would also be unable to inform emergency responders or other medical personnel about their medical history. They may therefore be unable to inform emergency responders about important information such as preexisting health conditions and allergies.

Crime victims, especially those who are traumatized or unconscious, may also be unable to communicate effectively with emergency responders and medical personnel. Emergency responders may also be unable to readily identify an unconscious crime victim, because the victim's wallet, containing his or her government-issued IDs, may have been stolen. In such cases, it is important for there to be another available means to identify the crime victim and get pertinent medical data about the crime victim. This may make a huge difference to the subsequent treatment of the victim.

A physician will consider the medical history of a patient to be critically important when deciding on the appropriate treatment for that patient. The physician will often decide on a patient's course of treatment based partially on that patient's medical history. As one example, a physician may choose that an antibiotic should not be administered to a patient if the patient is allergic to that particular antibiotic. As another example, a physician may also choose to administer certain medications more rapidly if the patient has a prior history of heart attacks. Therefore, in every situation, a physician will consider it advantageous to have access to a patient's medical history, when deciding how to medically treat that patient. A physician who has access to a patient's medical history will also be able to make more effective decisions about the appropriate treatment for the patient.

An important factor in many patients' chances of recovery is the speed with which the correct treatment is begun. Emergency room personnel and paramedics often spend a large amount of time acquiring pertinent background medical information related to persons who are unable to convey such information themselves. Precious treatment time can be wasted tracking down background medical history. Furthermore, medical personnel may sometimes run unnecessary tests on a patient to determine information which was already discovered earlier in that patient's medical history.

Tens of millions Americans presently have at least one medical condition that should be known by medical professionals during treatment and/or in times of emergency. These medical conditions include, but are not limited to, allergies, chronic diseases, drug dependencies and genetic predispositions. Accidents and medical emergencies can happen to anyone. Recent data reveals that 23% of emergency room admissions are injury or poisoning related. Another 15% are related to circulatory or respiratory problems.

The lives of many patients may therefore be saved by medical personnel's ability to quickly access a patient's medical history, information about the patient's next of kin or other family members, and the patient's other vital data.

If a physician at a medical center has access to a patient's medical history, he or she may be able to direct paramedics or other emergency responders on appropriate treatment steps to take while they are bringing the patient to the medical center. This will result in many patients being in much better condition when they arrive at the medical center, which, in turn, will result in the lives of many of these patients being saved.

Insurance premiums may also be reduced if a patient's medical history and other vital data can be quickly and accurately accessed by medical personnel. This is because, if medical personnel can quickly access a patient's medical history, they will be able to more quickly offer that patient the appropriate treatments and refrain from offering inappropriate treatments. This will reduce patients' medical costs, which in turn will reduce their insurance premiums.

Clearly, there is a need for a service that quickly and accurately informs physicians and other medical personnel about a patient's medical history, next of kin, and other vital data if the patient is found unconscious or is otherwise unable to communicate this information to the physician. The service should also be able to communicate information about the patient's medical history and next of kin to the physician before the patient arrives at the medical center where the physician is located. This way, the physician will be able to direct emergency responders on appropriate treatment steps to take while the patient is on the way to the medical center. This will probably improve patient outcomes. Furthermore, this service should include appropriate security measures, to be compliant with HIPAA, the Health Insurance Portability and Accountability Act (HIPAA), and the Emergency Medical Treatment and Active Labor Act (EMTALA). These laws both mandate various confidentiality and data security rules connected to data about a patient's health.

There is also a need for a service that will quickly and accurately inform physicians and other medical personnel about a crime victim's medical history, next of kin, and other vital data, and identity, in cases where the crime victim is unable to communicate this information and the crime victim's wallet or purse has been stolen. This service must also comply with HIPAA and EMTALA.

There is also a need for this patient medical history available through this service to be easy to update, because the appropriate course of treatment for a patient may change significantly depending on changes in the patient's medical history.

The United States Dept. of Health and Human Services is calling for national coordination for health information technology. The government is proposing electronic wrist-bands that can contain information on over 125 chronic medical conditions. The problem with electronic wrist-bands or other electronic devices is that they require periodic battery replacement or charging, are subject to damage from blows or shocks, and will usually not function after being placed in water. It would be advantageous to have an alternative to a wrist-band that did NOT contain any electronics, but could harness the power of the modern electronic/telecommunications world, especially the cellular telephone or smartphone, to immediately retrieve critical medical history by first responders and ER teams.

### Privacy and Data Security Concerns

Any service that includes stored information about a user's medical history, next of kin, and potentially other information such as the user's address must include appropriate safeguards to ensure that unauthorized individuals do not access the users' data. The objectives of the present invention require that the present invention also employ safeguards to ensure that criminals do not access the invention's users' data. The present invention includes such safeguards because, in most embodiments, the invention only releases medical history about the user to physicians or medical centers. Data is not released directly to emergency responders. However, a physician or medical center may choose to release user medical or other information to emergency responders, for the purpose of treating the user or contacting the user's next of kin.

Most embodiments of the invention envision a human-manned contact center, which has access to a medical history database (6) where the user's medical history, and information about next of kin, is stored. When contacted by an emergency responder, the personnel at the contact center forward the user's medical history, and information about next of kin, to the physician or medical center that will be treating the user. This provides the user's data with an additional layer of security.

Many inventions of the prior art suffer from a drawback, in that they provide insufficient security for a user's medical data. Our invention cures this issue, and provides adequate security for the user's medical data, through the above-described system, present in most embodiments of the invention.

### Some Objectives of the Invention

A first objective of the invention is to provide a method of easily retrieving medical history data, and/or data about emergency contacts (hereafter considered a subset of “personal contacts”), and/or legal documents that are supposed to take effect if the user becomes unconscious, for users who are unconscious or otherwise unable to give their medical history to emergency responders or to medical personnel. It is hoped that this will make medical treatment of these individuals more effective. A second objective of the invention is to ensure that this method of easily retrieving medical history data, data about personal contacts, and legal documents contains appropriate architecture to ensure confidentiality of the medical data, personal contact information, and legal documents, and that the method is compliant with HIPAA and EMTALA. A third objective of the invention is to provide an inexpensive physical object which will include identifiers, which will serve to identify a unique user of the above-mentioned method, so that this user's health, personal contact, and legal information, discussed above, can be retrieved. A fourth objective is to ensure that a user can, if desired, possess more than one of the inexpensive physical objects discussed above, which will include the same identifiers for the unique user, so that if the user is ever in a situation where the user needs emergency medical attention, the chances of an emergency responder finding at least one of the inexpensive physical objects discussed above will be higher.

A fifth objective is to ensure that when a patient is admitted to a medical center, that medical center has access to all of the patient's medical history quickly, without the patient having to give this information.

A sixth objective is to ensure that, if a user is found by an emergency responder, that emergency responder can be guided by a doctor who has all of the user's medical history available while the user is being transported to a hospital.

A seventh objective is to ensure that objects which are lost, such as cellular phones, can be identified easily by belonging to the user.

An eighth objective is to ensure that the inexpensive physical object discussed above is adhesive and so will not be lost easily.

### DESCRIPTION OF THE INVENTION

The first component of the invention is referred to here as the “Vital Data Assistant medallion”, or the “VDA medallion”. The VDA medallion is a small, thin, object with a QR code, an alphanumeric code, and a phone number on one face. This face may also be made of rough material, so that the medallion is rough to the touch and can be felt, located, and grasped more easily. This face may also contain “glow-in-the-dark” material, so that the phone number, alphanumeric code, or QR code can be seen in the dark. In this way, the VDA medallion can be detected more easily by emergency responders. The VDA medallion may have an adhesive material on the other face, so as to be able to adhere to objects. The VDA medallion should be small enough to adhere to, and fit on the side of, a standard cap of a lip balm container, or the side of an Incredicap™.

The inventor has tested small QR codes for medallions that fit on these objects, and they have functioned successfully as part of the invention.

The QR code on each VDA medallion should be unique.

It is possible to sell the VDA medallions in packs, with each VDA medallion in the pack having the same alphanumeric code. A group of the VDA medallions can otherwise be made available, with each medallion in the group having the same alphanumeric code. If a group of VDA medallions are sold or otherwise made available with this same alphanumeric code, and the user inputs each of the QR codes on these medallions via the initial subscription form (14), the databases (6), (20), (21), and (13) of the VDA system will assume that these VDA medallions refer to the same individual user.

It is recommended that the VDA medallion be made of durable, waterproof material, because this will allow the VDA medallion to survive even if it is subject to stress, such as being attached to an object that is thrown into water.

One form of the VDA medallion would be a durable, waterproof “sticker” that can be adhered to objects such as lip balm containers, or cellular phones.

Another form of the VDA medallion would be a thin, hard, durable, waterproof object with adhesive on one side, and a QR code, phone number, and alphanumeric code on the other side. This can also be adhered to objects such as lip balm containers, or cellular phones.

The user of the VDA medallion buys one or more VDA medallions, and then scans the QR code and alphanumeric code to open an “account” with Vital Data Assistant. The account is the repository of the user's information. The Querying Feature (23) presents an initial subscription form (14) to the user and then records all of the information about the user's health history that the user inputs. The user can also upload additional information about his or her medical history, besides what is asked in the initial subscription form. The initial subscription form will contain, at a minimum, all of the information requests that a person would normally be asked upon being admitted to a hospital for the first time. Health information can include information such as, but not limited to, name, height, weight, age, phone number, address, emergency contact, medical conditions, medication, allergies, primary and specialist physicians, procedures, operations, test results, advanced directives, family history, health history, cognitive and/or perceptional limitations, nutrition/metabolic concerns, values/beliefs/spiritual care, etc. The querying feature then places this information into the Medical History Database (6) with a record of the QR code and alphanumeric code identified by the user. The querying feature (23) also asks the user the identity and contact information of the person who the user wishes to be informed, if the user is admitted to a hospital or found by an emergency responder. This is usually the user's “next of kin”, and this information will be placed in the personal contact database (20). The querying feature (23) finally asks if the user has any documents, such as a living trust document, or will, that the user would like to be uploaded to the legal database (21). Any such information uploaded by the user is stored in the legal database (21). Additional instructions may be placed in the legal documents database. For example, if the user wishes for a certain person to take care of his pets while he is in the hospital, these instructions can be included in the legal database too. So can information about continuity of the user's business, if the user owns a business.

All three databases, the medical history database (6), personal contact database (20) and legal database (21) are stored on a computer readable medium (17) apart from the user. The information on these databases, pertaining to the user, is associated with that user only. This ensures that the information is available safely when needed. It is also envisioned that one embodiment of the querying feature (23), QR code recognition component, and alphanumeric code recognition component will be computer programs that can be run on a computer (16).

Alternatively, the medical history information, personal contact information, and legal document information can be associated together and placed in one database, the user information database (24).

The user should register the QR code and alphanumeric code of every VDA medallion that he or she possesses to his account. In this way, the health information, personal contact information, and legal information of that user will be associated with these QR codes and alphanumeric codes. This is necessary, because these QR codes and alphanumeric codes will be used to retrieve the user's information in an emergency. The QR code will be stored in the QR code database (12) and the alphanumeric code will be stored in the alphanumeric code database (13).

The VDA medallions could also be incorporated unobtrusively into conventional jewelry such as bracelets or necklaces.

If the user is ever in a situation where he or she is unconscious, traumatized, or otherwise in need of emergency assistance, and is contacted by an emergency responder, the emergency responder will locate the VDA medallion, and will scan the QR code with his cellular phone. The emergency responder will then call the phone number listed on the VDA medallion, send a copy of the QR code, and recite the alphanumeric code on the VDA medallion. The emergency responder must also authenticate himself or herself. The phone number will be connected to the contact center (7) and the individual answering the phone at the contact center (7) will use the querying feature (23) to query the QR code database (12) and the alphanumeric code database (13) with the QR code and alphanumeric code provided by the emergency responder. The QR code database and alphanumeric code database will then return the names of individuals associated with the entered QR codes the entered alphanumeric code to the querying feature (23), which will display any names that were returned by both the QR code database and the alphanumeric code database. There should be only one such name.

The medical, personal contact, and legal information associated with this name is then displayed. The contact center (7) uses the querying feature (23) to query the medical center database (15) about where the user should be transported to, if the user has indicated a preference. Alternatively, the emergency responder can suggest a facility. Either way, if this facility is in the medical center database (15), the contact center (7) sends the medical center (5) information that the user will be transported there, along with any information retrieved regarding the user from the medical history, personal contact, and legal documents databases.

The contact center (7) can also immediately notify the personal contact person of the user about the user's situation. The personal contact person can then immediately tell the contact center about any changes in the user's health that may have happened since the information in the medical history database (6) was placed on file. The contact center (7) will then pass this information on to the medical center (5).

The personnel of the medical center, if they so choose, will then contact the emergency responder and explain any steps which the emergency responder can or should take while the user is being transported to the medical center.

The releasing of information to medical centers only creates an extra level of security for the user's medical history.

In a second embodiment of the invention, the emergency responder will make sure to take a picture of both the alphanumeric code and the QR code with his cellular phone, and send this picture to the contact center. The contact center will then be able to authenticate the emergency responder's phone number or device ID, and thus determine that the picture came from an emergency responder's phone. The Contact Center can then use the querying feature to query the QR code database and the alphanumeric code database, for user information associated with the QR code and alphanumeric code that were in the picture sent by the emergency responder. Once the identity and information of the user are located, the contact center will contact the appropriate medical center and transmit the user's information to that medical center, along with instructions to expect the user to be delivered to that medical center.

In another embodiment of the invention, the user can choose, when signing up initially via the website, to release only medical history to the medical center, or to release medical history and emergency contact information, or to release medical history and legal documents.

In still another embodiment of the invention, the user, when signing up initially, can give the VDA service permission to import health care or other data from a third party source, such as a health insurance company's database or a government database. This third party would then send the data to the VDA service.

In still another embodiment of the invention, the contact center will be equipped with voice recognition technology (IVR) that authenticates the emergency responder's voice when the emergency responder phones the contact center. The emergency responder's voice would have to have been recorded ahead of time, for this to be effective.

In yet another embodiment of the invention, a location tracking feature, such as an app with location tracking capability, which would be on the user's cellular phone, would inform the contact center (7) of the user's location. Alternatively, a location tracking feature on the emergency responder's phone would inform the contact center (7) of the user's location.

Another embodiment of the invention could involve an emergency responder being granted automatic access to the medical history about the user contained within the medical history database, when the emergency responder scans the QR code on the VDA medallion or VDA sticker. The relevant medical history could be displayed on the emergency responder's cellular phone or IPAD.

Still another embodiment of the invention could involve a recognition program recognizing the emergency responder's QR cell phone by its device ID or the number that the phone is transmitting from. The service can then transmit the medical information specific to the user to the emergency responder's cellular phone or another display device.

In another embodiment, a live assistant at the contact center (7) would verify the credentials of the emergency responder, and then transmit the user's medical history to the emergency responder's cellular phone, or alternatively, to another display device (9).

The inventor advises against use of either of these three embodiments, for the following reasons, however. First, these three embodiments give insufficient protection to the user's medical history. There is a possibility that unauthorized persons may access the user's medical history. Second, emergency medical responders, in general, are not trained as physicians, and therefore should not be making medical decisions. Paramedics will have some medical training, but are generally trained to keep a patient stable until he arrives at a hospital. Police officers and firemen will generally have no medical training.

Those of skill in the art will appreciate that the disclosure may be practiced in other embodiments. First, the particular naming of the modules, capitalization of terms, the attributes, data structures, or any other programming or structural aspect is not mandatory or significant, and the mechanisms that implement the disclosure or its features may have different names, formats, or protocols. Further, the system and the individual modules may be implemented as either software code executed by the computer system, or as hardware elements with dedicated circuit logic, or a combination of hardware and software. Also, the particular division of functionality between the various system components described herein is merely exemplary, and not mandatory; functions performed by a single system module may instead be performed by multiple modules, and functions performed by multiple modules may instead performed by a single module.

In addition to being an emergency response product, the system can also act as a mobile medical notepad. The system is great for doctors office visits, as seniors over 65 years old have an average of 3 chronic conditions and take 3-10 Rx daily. Doctors say many people come to them and cannot remember their Rx information. The person can archive and share access from the desktop to smartphone. The person will no longer need to struggle with the names or dosages of their medications. The person will not have to remember the Rx that other specialists have written. The system is useful when the person has multiple specialists, medications, and dosages. The person can simply print or email information to their doctor's office to place in their medical file, or have the doctor scan the user's alphanumeric and QR codes. This ideal for doctor's visits, as the person can store all his prescriptions in a place that is easy to access.

In addition to being an emergency response product, the system can also help families manage and share medical information. As our population ages, children are taking a more active role in the management of their parents' healthcare. Through a password protected website, the user is allowed to share particular health information with their family. The user chooses which information they want others to see. The system is a simple and effective way to manage the health information of the user and his loved ones so medical providers can access the most essential health information fast. The system is ideal for parents, children, and loved ones, helping families manage their care from everywhere. Children can help track parents medication and diagnosis. Parents can help kids with epileptic, diabetic, and allergies (e.g., peanuts, bee stings, etc.).

FIG. 6 illustrates a process of a medical quick response according to an embodiment of the invention. The emergency responder locates the QR code. Then the emergency responder or medical personnel scan the QR code using the barcode reader on the mobile device. The barcode reader can be a QR iPhone or other cellular phone app. The mobile device then sends this information to the contact center, the emergency responder calls the contact center, and the contact center queries the databases and sends the person's medical data to the medical center. Personnel at the medical center communicate with the emergency responder.

The person's medical data can include emergency information such as the person's name, emergency contacts, medical conditions, allergies, and insurance information. The process may be repeated recursively a number of times.

In an emergency, the time treatment begins is critical. Time can be the difference between life, death, and debilitation. Emergency room doctors have stated that 90% of diagnosing a person in an emergency situation is having access to information. This information includes person medical history, emergency contacts, medications, allergies, medical implants, and insurance information. And too often, that information is not readily available. In the emergency room, nurses and technicians can spend hours wasting critical time trying to obtain this information.

If the user has an existing condition or is on medications, the system can save his life, as in an emergency, it is difficult to recall medications and dosages. With emergency medical services, an important factor is not only how quickly paramedics arrive at the scene, but how quickly they begin administering treatment. Because QR codes are two-dimensional pictures, there are a wider variety of different patterns that can be exhibited through a QR code than through an alphanumeric code in the same space. Furthermore, QR codes are much harder to duplicate and/or forge than alphanumeric codes. This is compounded by the fact that, when a cellular phone takes a picture of a QR code and emails it to a server, the server can often tell, from the background and coloration of the QR code, whether the QR code is “legitimate” or forged. All of this means that an emergency responder will actually have to take a picture of the QR code on a user's VDA medallion, and send it to the server, in order for the contact center to send the user's medical history to a medical center. It is extremely difficult to memorize the QR code ahead of time and then send it to the server. It is much more difficult than memorizing an alphanumeric code and sending it to the server, to gain access to a user's medical data, would be.

The QR code, added to an alphanumeric code, thus provides opportunities for security of an individual's health care data and other data, in a way that a QR code by itself, or an alphanumeric code by itself, does not.

Another potential problem with past inventions that release information about a user immediately upon an appropriate QR code being uploaded is that some cellular phones or other electronic devices may be able to take pictures of QR codes from a distance. The person holding such a phone would then have access to the user's information. In extreme cases, a malevolent third party could take a picture of a QR code associated with the user from a distance, gain access to information about the user's medical vulnerabilities, and then arrange to harm the user. Our invention is designed to prevent this scenario from happening.

### BRIEF DESCRIPTION OF THE DRAWINGS

FIG. 1 is an illustration of a VDA medallion, as envisioned by the inventor. The QR code, alphanumeric code, and phone number for an emergency responder to call are all clearly illustrated.

FIG. 2 is an illustration of a group of 4 VDA medallions, each with the same alphanumeric code, next to a container of lip balm. The VDA medallion is shown next to a lip balm container to illustrate its size.

FIG. 3 is a cross-section of a VDA medallion with an adhesive base and a rough surface. The adhesive base and the rough surface are clearly shown.

FIG. 4 is a flow chart of one embodiment of what happens when a user signs up, via the website, for the “vital data assistant” service and inputs his or her health information and other information into the website.

FIG. 5 is a flow chart of a different embodiment of what happens when a user signs up, via the website, for the “vital data assistant” service and inputs his or her health information and other information into the website.

FIG. 6 is a flow chart of one embodiment what happens when emergency responder finds an unconscious user and contacts the Vital Data Assistant service.

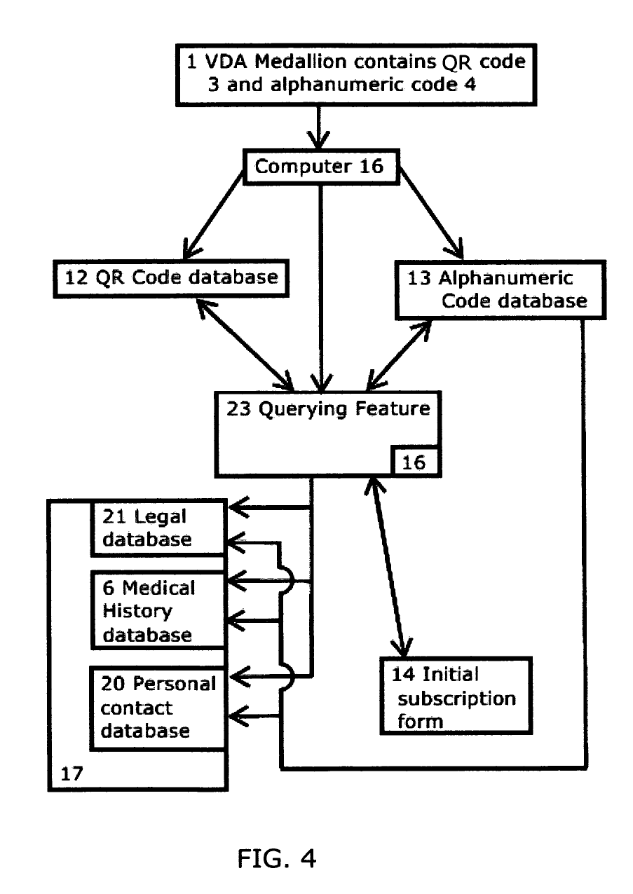

In FIGS. 4,5, and 6, lines between components indicate a relationship between the components, and an arrow pointing from one component to another indicates that data can flow from the first component to the second as part of one of the operations of the invention.

In all figures, boxes with sharp corners represent components of the invention, while boxes with rounded corners represent steps which are undertaken, by the components of the invention.

### DETAILED DESCRIPTION OF THE DRAWINGS

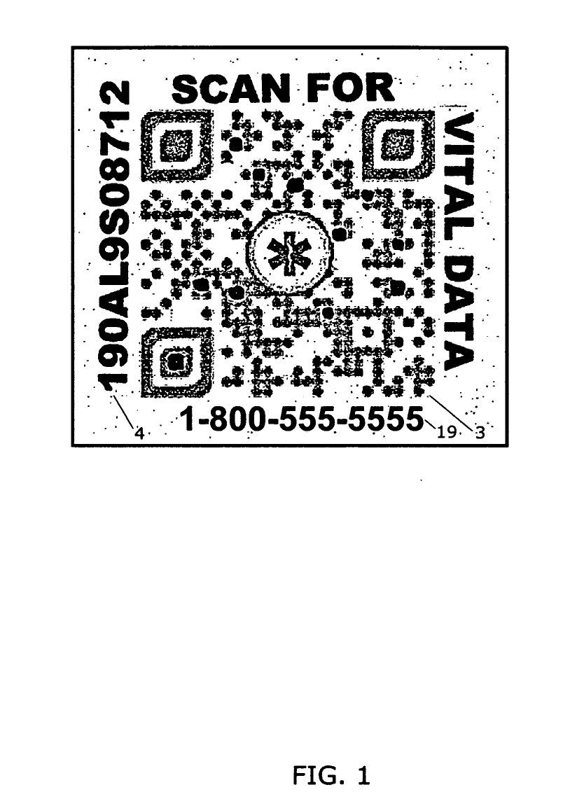

FIG. 1 is an illustration of a VDA medallion, as envisioned by the inventor. The QR code (3), alphanumeric code (4), and phone number (19) for an emergency responder to call are all clearly illustrated.

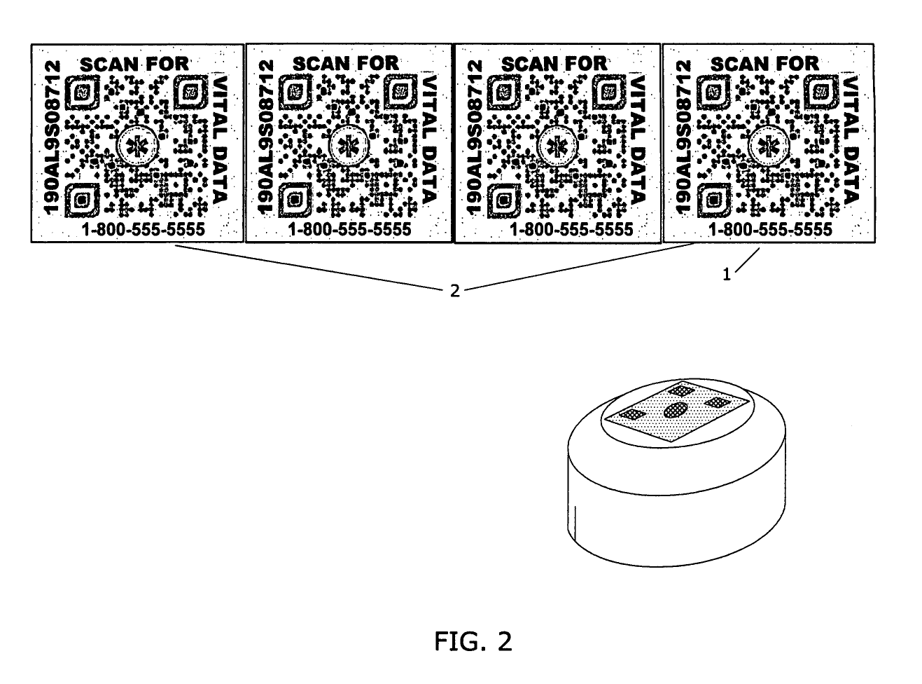

FIG. 2 is an illustration of a group of 4 VDA medallions, each with the same alphanumeric code, next to the cap of a container of lip balm. The user can place one of the VDA medallions on the lip balm container, and others in other locations. The user will be able to register the alphanumeric code with the Vital Data Assistant service, so that if any of the items which a VDA medallion is attached to is found by an emergency responder, the emergency responder can recite that alphanumeric code over the phone to the contact center, and the contact center will then be able to locate the user's medical and other information based on the QR code and the alphanumeric code that have been provided. Another VDA medallion has been placed on top of the cap of the lip balm container. This shows how VDA medallions can be attached to lipstick and lip balm containers and their caps, and illustrates one of the methods of attaching a VDA medallion to other things, for easy use.

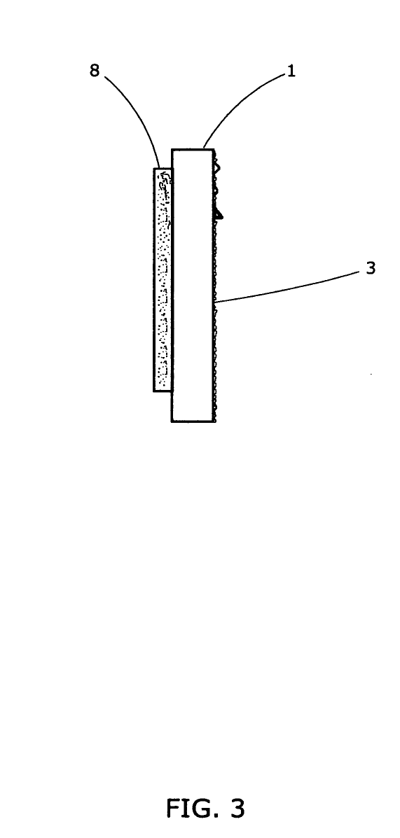

FIG. 3 is a cross-section of a VDA medallion with an adhesive base (8) and a rough surface. The adhesive base and the rough surface are clearly shown on opposite sides of the VDA medallion. This also indicates how a user may attach the VDA medallion to another object by affixing the adhesive base to that object, while allowing the QR code, alphanumeric code, and phone number to be viewed by anyone finding the VDA medallion. The adhesive base (8) may be larger or smaller than the particular adhesive base (8) indicated in this drawing, as long as the adhesive base can fulfill its function. Of adhering the VDA medallion to another object. The adhesive base (8) in this figure also has been drawn with the legend for “adhesive” listed in section 608.02 of the manual of patent examining procedure.

FIG. 4 is a flow chart of one example of what happens when a user signs up, via the website, for the “vital data assistant” service and inputs his or her health information and other information into the website. First, the user purchases the VDA medallion. The user subscribes via the website and inputs the QR code (3) and alphanumeric code (4) from the VDA medallion (1) that he has bought. The user uses a computer (16) to do this. The user's account is created and associated with the QR code (3) and alphanumeric code (4). The QR Code (3) is sent to the QR code database and recorded there, and the alphanumeric code is sent to the alphanumeric code database and recorded there.

The user is then given an initial subscription form (14). The querying feature (23) makes this initial subscription form (14) available to the user. The querying feature (23) is a program executed by a computer (16) in this embodiment. The user will input information about himself or herself into the initial subscription form (14). The user may also input health information about the user, information about emergency contacts or next-of-kin, and information such as the user's living trust or will. The health information is placed into by the querying feature into a user medical history database (6), the “emergency contact” or “next of kin” information is placed by the querying feature into a “personal contact” database (20), and information such as the user's living trust, will, or other instructions is placed by the querying feature into a “legal” database (21). The information in these three categories that is inputted by the user is associated with the QR code (3) and alphanumeric code (4) inputted by the user.

The querying feature can access databases (21), (6), and (20), and associates information in these databases pertaining to the user with the QR code (3), and alphanumeric code (4) which were inputted by the user when he or she signed up for the “vital data assistant” service. The querying feature can later access databases (21), (6), and (20) and retrieve information in databases (21), (6), and (20) that is associated with the QR code (3), and alphanumeric code (4) pertaining to the user.

The querying feature also has the ability to access the alphanumeric code database and find the user associated with a specific alphanumeric code, and access the QR code database and find the user associated with a specific QR code.

The databases (6), (20), and (21) are stored on a computer readable medium (17) in this embodiment, which makes placing information in, and searching, the databases (6), (20), and (21) easier and faster.

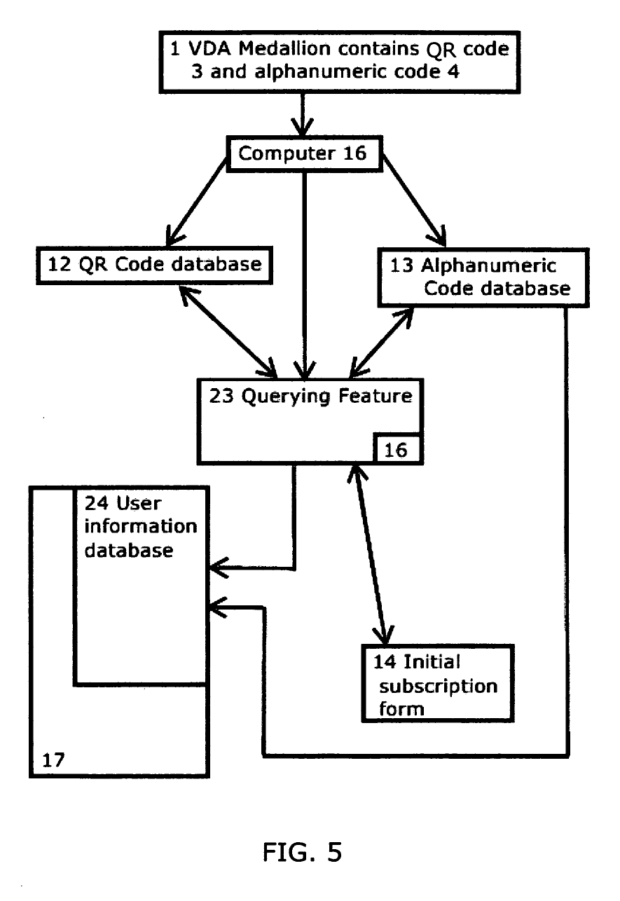

FIG. 5 is a flow chart of another possible when a user signs up, via the website, for the “vital data assistant” service and inputs his or her health information and other information into the website. First, the user purchases the VDA medallion. The user subscribes via the website and inputs the QR code (3) and alphanumeric code (4) from the VDA medallion (1) that he has bought. The user uses a computer (16) to do this. The user's account is created and associated with the QR code (3) and alphanumeric code (4). The QR Code (3) is sent to the QR code database (12) and recorded there, and the alphanumeric code is sent to the alphanumeric code database (13) and recorded there.

The user is then given an initial subscription form (14) by the querying feature (23). The querying feature (23) is a program executed by a computer (16) in this embodiment. The user will input information about himself or herself into the initial subscription form (14). The user may also input health information about the user, information about emergency contacts or next-of-kin, and information such as the user's living trust or will. The health information, personal contact information, and information such as the user's living trust, will, or other instructions are placed by the querying feature (23) in a “user information” database (24) and the querying feature (23) also associates this information with the QR code (3) and alphanumeric code (4) inputted by the user so that this information may be retrieved later from the user information database via accessing the QR code (3) and alphanumeric code (4).

The querying feature can access database (24), and associates information in this database pertaining to the user with the QR code (3), and alphanumeric code (4) which were inputted by the user when he or she signed up for the “vital data assistant” service. The querying feature can later access database (24) and retrieve information in database (24) that is associated with the QR code (3), and alphanumeric code (4) pertaining to the user. The querying feature also has the ability to access the alphanumeric code database and find the user associated with a specific alphanumeric code, and access the QR code database and find the user associated with a specific QR code.

The databases (6), (20), and (21) are stored on a computer readable medium (17) in this embodiment, which makes placing information in, and searching, the databases (6), (20), and (21) easier and faster.

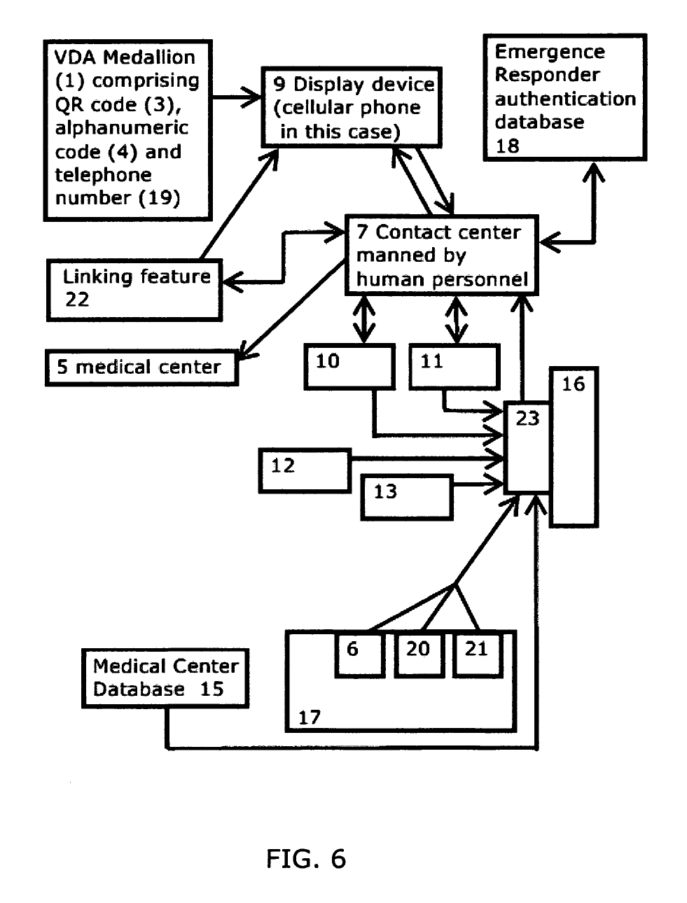

FIG. 6 is a flow chart of one possible chain of events which happens when an emergency responder finds an unconscious user and contacts the Vital Data Assistant service.

The emergency responder finds an unconscious user and notices that the user possesses VDA medallion (1). The emergency responder then uses his cellular phone (a display device) (9) to scan the QR code (3) and send it to the contact center (7). The emergency responder then communicates the alphanumeric code (4) to the contact center (7). The contact center (7) verifies the emergency responder's identity with help from the emergency responder authentication database (18) (which the contact center (7) can investigate to verify the emergency responder's identity if necessary). The emergency responder authentication database (18) can be configured to include, among other things, the device IDs of phones possessed by emergency responders, so that the contact center can easily verify the identity of an emergency responder by learning the device ID of the emergency responder's phone and then locating this in the emergency responder authentication database. The QR code recognition component (10) recognizes that the emergency responder has sent a QR code (3). The alphanumeric code recognition component recognizes that the emergency responder has sent an alphanumeric code (4). In this embodiment of the invention, the linking feature (22) will then connect the contact center (7) to the display device (9) so that data may be interchanged more easily.

The QR code is sent by the QR code recognition component (10) to the querying feature (23) and the alphanumeric code (4) is sent by the alphanumeric recognition component (11) to the querying feature (23), and then the querying feature searches the QR code database (12) for the relevant QR code and the alphanumeric code database (13) for the relevant alphanumeric code sent by the emergency responder. The querying feature (23) is a program executed by a computer (16) in this embodiment. The information in the medical history database (6), personal contact database (20), and legal database (21) pertaining to the user are all associated with the QR code and alphanumeric code previously registered by the user, so when the querying feature finds the QR code and alphanumeric code that the emergency responder has sent, the querying feature will also find all information in databases (6), (20), and (21) that is associated with that specific QR code and alphanumeric code. The querying feature returns all data in the medical history database (6), personal contact database (20), and legal database (21) that is associated with the specific QR code and alphanumeric code that the emergency responder has sent. This information is sent to the contact center (7). The databases (6), (20), and (21) are stored on a computer readable medium (17) in this embodiment, which makes searching the databases (6), (20), and (21) easier and faster. The emergency responder informs the contact center (7) of the medical center (5) to which the user will be taken, and the contact center (7) sends the user's medical history information, personal contact information, and legal information to the medical center (5). This can be accomplished via sending large data files over the internet, which will probably be one of the faster methods for the user's medical history information, personal contact information, and legal information to be sent to the medical center (7).

After the emergency responder is authenticated through the emergency responder database (18) and the QR code (3) and alphanumeric code (4) are found in the QR code database and alphanumeric code database, respectively, the contact center personnel may use the querying feature (23) to query the medical center database (15) to determine if the user has instructed that he or she should be carried to a specific medical center. If the medical center is selected by other means, the medical center database (15) may also be queried for the contact information for the medic al center to which the user will be transported.

1. A medallion made of waterproof material, comprising two faces, one of which further comprises a QR code, an alphanumeric code, and a phone number, and small enough that said medallion can adhere to the outer surface of a standard-diameter cap of lipstick or lip balm in a manner allowing that a single picture taken of the medallion with a cellular phone's camera feature or another digital camera can show the whole of the QR code and the whole of the alphanumeric code, in a manner allowing the QR code to be recognized by a program or other software feature that recognizes QR codes;
where the user may input the QR code, and the alphanumeric code, into an Internet site, and can also input medical history information about the user, personal contact information about the user, and legal information about the user into the Internet site, and the QR code is placed into a QR code database, the alphanumeric code is placed into an alphanumeric code database, and the medical history information, personal contact information, and legal information about the user are and associated with the QR code and alphanumeric code provided by the user, and where said medical history information, personal contact information, and legal information about the user are placed in one or more secure databases;
and where said phone number connects to a contact center, and said contact center has access to a querying feature, which has the ability to query said QR code database and said alphanumeric code database and to retrieve information from the databases in which said medical history information, personal contact information, and legal history information are stored, when said medical history information, personal contact information, and legal history information are associated with said QR code and said alphanumeric code;
so that when an emergency responder or other individual scans the QR code with his cellular phone or other digital scanning device and sends the QR code to said contact center and communicates said alphanumeric code to said contact center, the contact center verifies that the individual who has sent the contact center the QR code and alphanumeric code is an emergency responder,
and then uses said querying feature to access said QR code database and said alphanumeric code database, and said querying feature accesses said QR code database and said alphanumeric code database and returns the identity and medical history information, personal contact information, and legal information of any user when said medical history information, personal contact information, and legal information associated with both said QR code and said alphanumeric code, and the contact center then contacts a medical center and then via electronic means sends said medical center said identity and medical history information, personal contact information, and legal information from the databases where said medical history information, personal contact information, and legal information are stored.

2. A medallion made of waterproof material, comprising two faces, one of which further comprises a QR code, an alphanumeric code, and a phone number, and small enough that said medallion can adhere to the outer surface of a standard-diameter cap of lipstick or lip balm in a manner allowing that a single picture taken of the medallion with a cellular phone's camera feature or another digital camera can show the whole of the QR code and the whole of the alphanumeric code, in a manner allowing the QR code to be recognized by a program or other software feature that recognizes QR codes;
where the user may input the QR code, and the alphanumeric code, into an Internet site, and can also input medical history information about the user, personal contact information about the user, and legal information about the user into the Internet site, and the QR code is placed into a QR code database, the alphanumeric code is placed into an alphanumeric code database, and the medical history information, personal contact information, and legal information about the user are and associated with the QR code and alphanumeric code provided by the user, and where said medical history information, personal contact information, and legal information about the user are placed in one or more secure databases;
and where said phone number connects to a contact center, and said contact center has access to a querying feature, which has the ability to query said QR code database and said alphanumeric code database and to retrieve information from the databases in which said medical history information, personal contact information, and legal history information are stored, when said medical history information, personal contact information, and legal history information are associated with said QR code and said alphanumeric code;
so that when an emergency responder or other individual scans the QR code with his cellular phone or other digital scanning device and sends the QR code to said contact center and communicates said alphanumeric code to said contact center, the contact center verifies that the individual who has sent the contact center the QR code and alphanumeric code is an emergency responder,
and then said contact center uses said querying feature to access said QR code database and said alphanumeric code database, and said querying feature accesses said QR code database and said alphanumeric code database and returns the identity and medical history information, personal contact information, and legal information of any user when said medical history information, personal contact information, and legal information associated with both said QR code and said alphanumeric code, and the contact center then contacts a medical center and then via electronic means sends said medical center said identity and medical history information, personal contact information, and legal information from the databases where said medical history information, personal contact information, and legal information are stored, and places said medical center in contact with said emergency responder; and said contact center also notifies the personal contact of the user that the contact center has received information about the user, when said personal contact is listed in the personal contact information.

3. A piece of jewelry containing a medallion made of waterproof material, further comprising two faces, one of which further comprises a QR code, an alphanumeric code, and a phone number, and small enough that said medallion can adhere to the outer surface of a standard-diameter cap of lipstick or lip balm in a manner allowing that a single picture taken of the medallion with a cellular phone's camera feature or another digital camera can show the whole of the QR code and the whole of the alphanumeric code, in a manner allowing the QR code to be recognized by a program or other software feature that recognizes QR codes;
where the user may input the QR code, and the alphanumeric code, into an Internet site, and can also input medical history information about the user, personal contact information about the user, and legal information about the user into the Internet site, and the QR code is placed into a QR code database, the alphanumeric code is placed into an alphanumeric code database, and the medical history information, personal contact information, and legal information about the user are and associated with the QR code and alphanumeric code provided by the user, and where said medical history information, personal contact information, and legal information about the user are placed in one or more secure databases;
and where said phone number connects to a contact center, and said contact center has access to a querying feature, which has the ability to query said QR code database and said alphanumeric code database and to retrieve information from the databases in which said medical history information, personal contact information, and legal history information are stored, when said medical history information, personal contact information, and legal history information are associated with said QR code and said alphanumeric code;
so that when an emergency responder or other individual takes a picture of the QR code and alphanumeric code with his cellular phone or other digital scanning device and sends this picture to said contact center, and upon receipt of said picture by said contact center, said querying feature immediately queries said QR code database for QR codes and alphanumeric codes, respectively, that match the QR code and alphanumeric code sent by said emergency responder, and said querying feature and returns the identity and medical history information, personal contact information, and legal information of any user when said medical history information, personal contact information, and legal information associated with both said QR code and said alphanumeric code,
and said contact center verifies the identity of said emergency responder,
and the contact center then contacts a medical center and then via electronic means sends said medical center said identity and medical history information, personal contact information, and legal information from the databases where said medical history information, personal contact information, and legal information are stored, and places said medical center in contact with said emergency responder.

4. The medallion of claim 1 when said medallion is rectangular.

5. The medallion of claim 1 where said medallion is composed of material that is hard enough to break the glass of an automobile window.

6. The medallion of claim 2 where portions of said medallion are comprised of glow-in-the-dark material so that said medallion is easier to see in the dark.
A method of providing emergency response data and medical care comprising the following steps; providing the user with a medallion made of waterproof material, comprising two faces, one of which further comprises a QR code, an alphanumeric code, and a phone number, and which is small enough that said medallion can adhere to the outer surface of a standard-diameter cap of lipstick or lip balm in a manner allowing that a single picture taken of the medallion with a cellular phone's camera feature or another digital camera can show the whole of the QR code and the whole of the alphanumeric code, in a manner allowing the QR code to be recognized by a program or other software feature that recognizes QR codes;
and a medallion made of waterproof material, comprising two faces, one of which further comprises a QR code, an alphanumeric code, and a phone number, and which is small enough that said medallion can adhere to the outer surface of a standard-diameter cap of lipstick or lip balm in a manner allowing that a single picture taken of the medallion with a cellular phone's camera feature or another digital camera can show the whole of the QR code and the whole of the alphanumeric code, in a manner allowing the QR code to be recognized by a program or other software feature that recognizes QR codes;
providing instructions for the user to input the QR code, and the alphanumeric code, into an Internet site, and to input medical history information about the user, personal contact information about the user, and legal information about the user into the Internet site, where the QR code is placed into a secure QR code database, the alphanumeric code is placed into a secure alphanumeric code database, and the medical history information, personal contact information, and legal information about the user are associated with the QR code and alphanumeric code provided by the user, and where said medical history information, personal contact information, and legal information about the user are placed in one or more secure databases which are designated to store medical history information of a user, personal contact information of a user, and legal information of a user;
and where said phone number connects to a contact center, and said contact center has access to a querying feature, which has the ability to query said QR code database and said alphanumeric code database and to retrieve information from the databases in which said medical history information, personal contact information, and legal history information are stored, when said medical history information, personal contact information, and legal history information are associated with said QR code and said alphanumeric code;
so that when an emergency responder or other individual scans the QR code with his cellular phone or other digital scanning device and sends the QR code to said contact center and communicates said alphanumeric code to said contact center, the contact center verifies that the individual who has sent the contact center the QR code and alphanumeric code is an emergency responder,
and then said contact center uses said querying feature to access said QR code database and said alphanumeric code database, and said querying feature accesses said QR code database and said alphanumeric code database and returns the identity and medical history information, personal contact information, and legal information of any user when said medical history information, personal contact information, and legal information associated with both said QR code and said alphanumeric code, and the contact center then contacts a medical center and then via electronic means sends said medical center said identity and medical history information, personal contact information, and legal information from the databases where said medical history information, personal contact information, and legal information are stored.

7. The method of claim 6, further comprising an “app” on the user's cellular phone which connects to said contact center.

8. A system for ensuring that medical, and legal information of a user and information regarding personal contacts of a user are available when needed, said system comprising the following; a contact center, a computer readable medium on which is stored a secure QR Code database, a secure alphanumeric code database, and one or more secure databases which are designated to store medical history information of a user, said personal contact information of a user, and legal information of a user; a querying feature which can access said databases, and which is a computer program stored on a specially programmed computer;
and a medallion made of waterproof material, comprising two faces, one of which further comprises a QR code, an alphanumeric code, and a phone number, and which is small enough that said medallion can adhere to the outer surface of a standard-diameter cap of lipstick or lip balm in a manner allowing that a single picture taken of the medallion with a cellular phone's camera feature or another digital camera can show the whole of the QR code and the whole of the alphanumeric code, in a manner allowing the QR code to be recognized by a program or other software feature that recognizes QR codes;
and where said phone number connects to a contact center, and said contact center has access to a querying feature, which has the ability to query said QR code database and said alphanumeric code database and to retrieve information from the databases in which said medical history information, personal contact information, and legal history information are stored, when said medical history information, personal contact information, and legal history information are associated with said QR code and said alphanumeric code;
so that when an emergency responder or other individual scans the QR code with his cellular phone or other digital scanning device and sends the QR code to said contact center and communicates said alphanumeric code to said contact center, the contact center verifies that the individual who has sent the contact center the QR code and alphanumeric code is an emergency responder,
and then said contact center uses said querying feature to access said QR code database and said alphanumeric code database, and said querying feature accesses said QR code database and said alphanumeric code database and returns the identity and medical history information, personal contact information, and legal information of any user when said medical history information, personal contact information, and legal information associated with both said QR code and said alphanumeric code, and the contact center then contacts a medical center and then via electronic means sends said medical center said identity and medical history information, personal contact information, and legal information from the databases where said medical history information, personal contact information, and legal information are stored.

9. The system of claim 8 further comprising an “app” on the user's cellular phone which connects to said contact center.

10. The medallion of claim 1 wherein said health information consists of at least one selected from the group consisting of medical history, surgical history, recent lab/test results, imaging studies, blood type, immunization history, medical device information, family history, social history, allergies, DNRs, genetic information, power(s) of attorney, living will, next-of-kin contact information, current medications, current supplements, current vitamins, drug tests, name and contact information for current physician.

11. The medallion of claim 1 where said user's medical history information, user's personal contact information, and legal information are stored in the same database.

12. The medallion of claim 1 where said user's medical history information is stored in a medical history database, said user's personal contact information is stored in a personal contact database, and said user's legal information is stored in a legal database.

13. The medallion of claim 1 where said medallion is rough to the touch, so that a user can more easily find the medallion through touch.

14. The medallion of claim 1 where said medical center is selected by the user when he inputs medical history information, personal contact information, and legal information into said internet site, and said medical center is placed into a medical center database.

15. The system of claim 8, further comprising that said medallions are offered to the user in groups of 2 or more, and these medallions all have the same alphanumeric code.

16. The method of claim 6, further comprising that said medallions are offered to the user in groups of 2 or more, and these medallions all have the same alphanumeric code.

17. The method of claim 6, further comprising that said medallion is adhesive on one of its faces.

18. The method of claim 6, further comprising that said medallion is rough to the touch, so as to be found by touch more easily.

19. The system of claim 8, further comprising that said medallion is adhesive on one of its faces.

20. The system of claim 8, further comprising that said medallion is rough to the touch, so as to be found by touch more easily.
